(19) United States
(12) Patent Application Publication
(10) Pub. No.: US 2005/0264479 A1
(43) Pub. Date: Dec. 1, 2005

(54) Plasma display device and driving method of plasma display panel

(76) Inventors: Kazuhiro Ito, Suwon-si (KR); Byung-Gwon Cho, Suwon-si (KR)

Correspondence Address: CHRISTIE, PARKER & HALE, LLP, PO BOX 7068, PASADENA, CA, 91109-7068, US

(21) Appl. No.: 11/133,906

(22) Filed: May 21, 2005

(30) Foreign Application Priority Data
May 28, 2004 (KR) 10-2004-0038298
May 31, 2004 (KR) 10-2004-0038966
May 31, 2004 (KR) 10-2004-0038987

(51) Int. Cl. G09G 3/28

(52) U.S. Cl. 345/60

(57) ABSTRACT

A method for driving a plasma display panel having a plurality of scan, sustain, and address electrodes is presented. Reset, address, and sustain discharge are performed by applying a driving waveform to a scan electrode while the sustain electrode is biased at a ground voltage. Address electrode is set to be at a positive voltage while the voltage of the scan electrode is gradually increased during the reset period. The foregoing driving voltage scheme obviates the need for a separate driving board for the sustain electrode. A single integrated board is sufficient for driving the scan and sustain electrodes. Various slopes for rising and falling portions of the scan waveform during the reset period are presented. A falling only reset period in second and subsequent subfields is used.

### CROSS-REFERENCES TO RELATED APPLICATIONS

This application claims priority to and the benefit of Korean Patent Applications No. 10-2004-0038298 filed on May 28, 2004; No. 10-2004-0038966 filed on May 31, 2004; and No. 10-2004-0038987 filed on May 31, 2004, all filed in the Korean Intellectual Property Office, the entire contents of which are incorporated herein by reference.

### BACKGROUND OF THE INVENTION

1. Field of the Invention

The present invention relates to a method for driving a plasma display panel and to a plasma display device, and in particular to a driving voltage scheme that eliminates a need for separate driving boards for the different driving electrodes.

2. Description of the Related Art

A plasma display panel (PDP) is a flat panel display that uses plasma generated by gas discharge in discharge cells to display characters or images. Depending on its size, a PDP includes more than several tens to millions of pixels arranged in a matrix pattern. One frame of the PDP is defined as a period of time during which all of the pixels in the panel are addressed. One frame is divided into a plurality of subfields, and each subfield includes a reset period, an address period, and a sustain period.

The reset period is for initializing the status of each discharge cell so as to facilitate an addressing operation on the discharge cell. The address period is for selecting turn-on/turn-off cells, that are the cells that must be turned on or turned off to display the intended image, and for accumulating wall charges on the turn-on cells that are addressed to be turned on. The sustain period is for causing the cells to either continue discharge for displaying an image on the addressed cells or remain inactive.

In order to perform the above operations and to display an image, sustain pulses are alternately applied to scan electrodes and sustain electrodes during the sustain period, and reset waveforms and address waveforms are applied to the scan electrodes during the reset period and the address period. Therefore, a scan driving board for driving the scan electrodes and a sustain driving board for driving the sustain electrodes are separately needed. Mounting the two separate driving boards on a chassis base may generate problems and increase the overall cost of the device.

For combining the two driving boards into a single combined board, schemes of coupling the single combined board to the scan electrodes and extending the sustain electrodes to reach the combined board have been proposed. However, when the two driving boards are combined as such, the impedance component created at the extended sustain electrodes is increased.

### SUMMARY OF THE INVENTION

The present invention provides a plasma display device having a single integrated board for driving a scan electrode and a sustain electrode. The present invention also provides a driving waveform for the single integrated board. A driving waveform is applied to an electrode while another electrode is biased at a constant voltage. An exemplary embodiment of this invention presents a method for driving a PDP. A PDP typically includes a scan electrode, a sustain electrode, and an address electrode, the scan electrode and the sustain electrode forming a parallel pair and the address electrode extending perpendicular to the parallel pair, the method driving the plasma display panel during frames, each frame having subfields, each subfield having a reset period followed by an address period followed by a sustain period, the reset period including a rising period and a falling period.

The exemplary method for driving a PDP includes maintaining the sustain electrode biased at a first voltage, during each subfield; gradually increasing a voltage of the scan electrode from a second voltage to a third voltage, during the rising period; decreasing the voltage of the scan electrode from the third voltage to a fourth voltage; gradually decreasing the voltage of the scan electrode from the fourth voltage to a fifth voltage, during the falling period; selecting a discharge cell by applying a scan voltage and a non-scan voltage to the scan electrode and applying an address pulse to the address electrode, during the address period; and sustain-discharging the selected discharge cell by applying a pulse alternately having a sixth voltage and a seventh voltage lower than the sixth voltage to the scan electrode, during the sustain period. The address electrode may be biased at an eighth voltage during the falling period and a portion of the address period. In a variation, the address electrode may be biased at a ninth voltage more positive than the eighth voltage during the entire rising period. In another variation, the address electrode may be biased at a ninth voltage more positive than the eighth voltage during a portion of the rising period. In yet another variation, the voltage of the address electrode may be gradually increased to a voltage more positive than the eighth voltage during a portion of the rising period. In a further variation, the address electrode may be floated during the rising period.

In the method disclosed for driving the PDP, the ninth voltage may be equal to an address pulse voltage. The first voltage may be a ground voltage. The fourth voltage may be a ground voltage. The sixth voltage may be equal to the fourth voltage. The eighth voltage may be a ground voltage. The third voltage may be a positive voltage, the fifth voltage a negative voltage with an absolute value greater than the third voltage, and the fourth voltage lower than the ground voltage and higher than a sum of the third voltage and a voltage twice the fifth voltage. In one embodiment the voltage of the scan electrode may be decreased from the third voltage to the sixth voltage and from the sixth voltage to the ground voltage, between the rising period and the falling period, and then gradually decreased from the ground voltage to the fifth voltage, during the falling period.

The subfields may be set up such that the reset period of a first subfield includes a rising period and a falling period, and reset periods of subsequent subfields include a falling period only. In that case the voltage of the scan electrode may be gradually decreased from the fourth voltage to the fifth voltage, during the falling period of a subsequent subfield. Gradually decreasing the voltage of the scan electrode from the fourth voltage to the fifth voltage, during the falling period of a subsequent subfield, may include first decreasing the voltage of the scan electrode from the fourth voltage to ground and then gradually decreasing the voltage of the scan electrode from ground to the fifth voltage.

A plasma display device is also presented that includes a PDP, a control board for dividing a frame into a plurality of subfields, and a driving board for applying a driving waveform, for displaying an image on the plasma display panel, to the scan electrodes and to the address electrodes, and for biasing the sustain electrodes at a first voltage during the plurality of subfields. The driving board generates a discharge for initializing a cell during a reset period of at least one subfield, the discharge generated first between the scan electrodes and the address electrodes and then between the scan electrodes and sustain electrodes. The driving board may generate a discharge by gradually increasing a voltage of the scan electrodes and subsequently gradually decreasing the voltage of the scan electrodes. The driving board may generate the discharge by gradually decreasing the voltage of the scan electrodes from the reference voltage. The driving board may generate the discharge by gradually decreasing the voltage of the scan electrodes from a voltage lower than the reference voltage. The driving board may apply a voltage to the address electrodes during a period when the driving board gradually increases the voltage of the scan electrodes, the voltage applied being more positive than a voltage applied to the address electrodes during a period when the driving board gradually decreases the voltage of the scan electrodes. The driving board may apply a pulse alternately having a voltage higher than a reference voltage and a voltage lower than the reference voltage to the scan electrodes in order to perform a sustain discharge.

### BRIEF DESCRIPTION OF THE DRAWINGS

FIG. 1 shows an exploded perspective view of a plasma display device according to an exemplary embodiment of the present invention.

FIG. 2 shows a schematic view of a plasma display panel according to an exemplary embodiment of the present invention.

FIG. 3 shows a plan view of a chassis base of a plasma display device according to an exemplary embodiment of the present invention.

FIG. 4 shows a driving waveform according to a first exemplary embodiment of the present invention.

FIG. 5 shows wall charge condition of a cell in which a strong discharge is generated during a reset period.

FIG. 6, FIG. 7, FIG. 8, FIG. 9, FIG. 10, FIG. 11, FIG. 12, and FIG. 13 show driving waveforms of a plasma display panel according to second to ninth exemplary embodiments of the present invention, respectively.

FIG. 14 shows wall charge condition of a cell after a sustain discharge ends.

### DETAILED DESCRIPTION

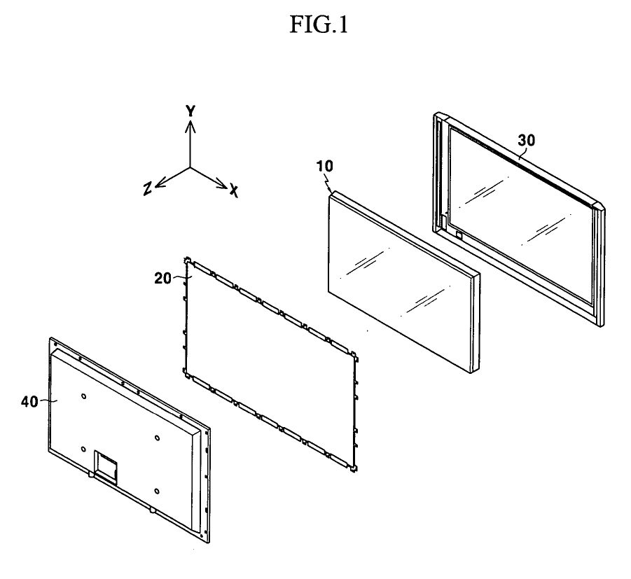

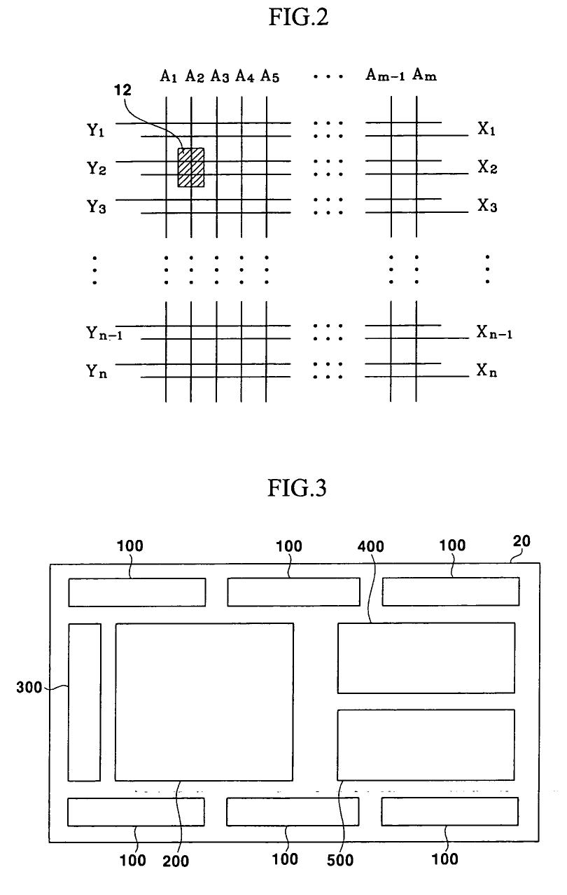

A schematic configuration of a plasma display device according to an embodiment of the present invention is shown in FIG. 1, FIG. 2, and FIG. 3.

As shown in FIG. 1, the plasma display device includes a plasma display panel 10, a chassis base 20, a front case 30, and a rear case 40. The chassis base 20 is coupled to the plasma display panel 10 opposite an image display side of the plasma display panel 10. The front case 30 is coupled to the plasma display panel 10 on the image display side of the plasma display panel 10. The rear case 40 is coupled to the chassis base 20. The assembly of these parts forms a plasma display device.

As shown in FIG. 2, the PDP 10 of FIG. 1 includes a plurality of address (A) electrodes A₁ to Aₘ extending in a column direction, and a plurality of scan (Y) electrodes Y₁ to Yₙ and a plurality of sustain (X) electrodes X₁ to Xₙ each extending in a row direction. The respective sustain electrodes X₁ to Xₙ correspond to the respective scan electrodes Y₁ to Yₙ. The subpixel area delineating a discharge space where the A electrodes cross the Y and X electrodes forms a discharge cell 12.

As shown in FIG. 3, driving boards 100, 200, 300, 400, 500 for driving the plasma display panel 10 are formed on the chassis base 20. Address buffer boards 100 are formed on a top and a bottom of the chassis base 20. The configuration shown is considered a dual driving scheme, providing address voltages from both top and bottom sides of the chassis 20, and may be altered depending on the driving scheme. For example, in a single driving scheme, the address buffer boards 100 may be located on either the top or the bottom of the chassis base 20. Further, the address buffer board 100 may be formed as a single board or a combination of a plurality of boards.

The address buffer board 100 receives an address driving control signal from a control board 400 and applies a voltage for selecting a turn-on cell to the appropriate A electrodes. The X electrodes are biased at a constant sustain voltage.

A scan driving board 200 is located to the left of the chassis base 20 and is coupled to the Y electrodes through a scan buffer board 300. During an address period, the scan buffer board 300 applies a voltage to the Y electrodes for sequentially selecting scan electrodes Y1 to Yn. The scan driving board 200 receives a driving signal from the control board 400 and applies a driving voltage to the selected Y electrode. While, in FIG. 3, the scan driving board 200 and the scan buffer board 300 are shown on the left side of the chassis base 20, they may be located on the right side of the chassis base 20. Also, the scan buffer board 300 and the scan driving board 200 may be formed together as one integral part.

Externally receiving an image signal, the control board 400 generates a control signal for driving the A electrodes and a control signal for driving the Y and X electrodes. The control board 400 subsequently applies the control signals to the address buffer board 100, the scan driving board 200, and the scan buffer board 300. A power supply board 500 supplies the power for driving the plasma display device. The control board 400 and the power supply board 500 are located on a central area of the chassis base 20.

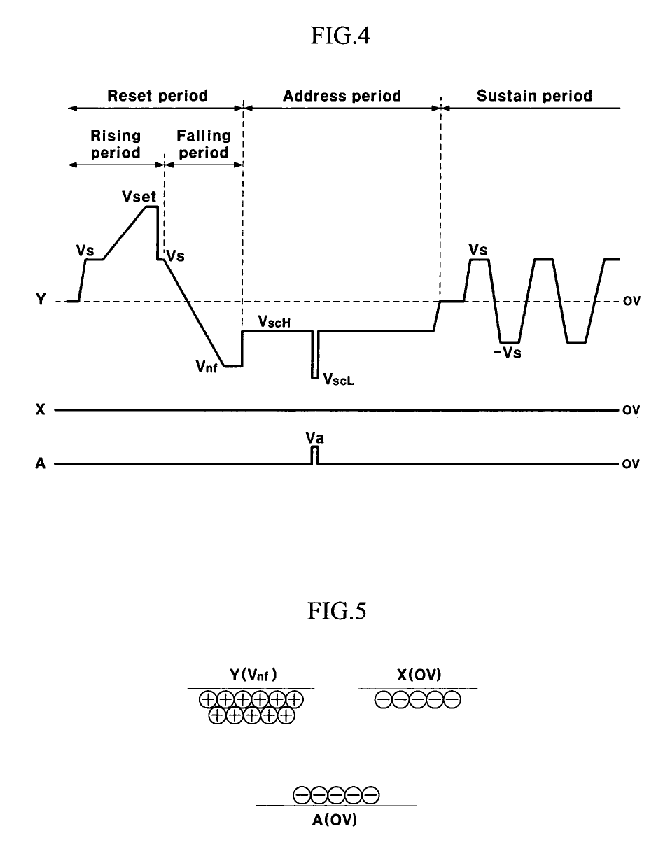

FIG. 4 shows driving waveforms of the plasma display panel according to a first exemplary embodiment of the present invention. For convenience of description, driving waveforms applied to a Y electrode, a X electrode, and an A electrode are exemplarily described in connection with only one cell 12 (FIG. 2). In the driving waveform shown in FIG. 4, and referring to FIG. 3, the Y electrode receives a voltage from the scan driving board 200 and the scan buffer board 300, and the A electrode receives a voltage from the address buffer board 100. The X electrode is biased at a constant reference voltage, represented as a ground voltage (0V) in FIG. 4.

As explained above, a PDP is driven during frames and frames are divided into subfields. As shown in FIG. 4, one subfield of the driving waveform is divided into three periods, the reset period, the address period, and the sustain period. The reset period has a rising period and a falling period.

During the rising period of the reset period, the voltage of the Y electrode is gradually increased from a voltage of Vs to a voltage of Vset while the A electrode is maintained at the reference voltage that is represented by the 0V line in FIG. 4. The voltage of the Y electrode increases in a ramp between Vs and Vset. As the voltage of the Y electrode is increased, a weak discharge is generated between the Y and X electrodes and between Y and A electrodes, and (−) wall charges are formed on the Y electrode and (+) wall charges are formed on the X and A electrodes. In addition, when the voltage of the Y electrode changes gradually, as shown in FIG. 4, a weak discharge is caused in a cell 12 (FIG. 2), and accordingly, wall charges are formed such that a sum of an externally applied voltage and the wall charge may be maintained at a discharge firing voltage.

Wall charges being described in the present invention refer to charges formed on a wall of a discharge cell 12 (FIG. 2) close to each electrode (X, Y, or A) and accumulated on the electrode. The wall charge is described as being “formed” or “accumulated” on the electrode (X, Y, or A) although the wall charges do not actually touch the electrodes. Further, a wall voltage, Vw, means a potential difference formed between the walls of the discharge cell 12 (FIG. 2) by the wall charges.

The voltage Vset is a voltage high enough to fire a discharge in cells 12 of any condition because every cell 12 (FIG. 2) has to be initialized during the reset period. Generally, the voltage Vs is equal to the voltage applied to Y electrode during the sustain period, and is less than a voltage required for firing discharge between the Y electrode and X electrode.

During the falling period of the reset period, the voltage of Y electrode is gradually reduced from the voltage Vs to a voltage Vnf while the voltage of the A electrode is maintained at the reference voltage. As a result, a weak discharge is generated between the Y and X electrodes and between the Y and A electrodes while the voltage of the Y electrode is reduced, and accordingly, the (−) wall charges formed on the Y electrode and the (+) wall charges formed on the X and A electrodes are eliminated. The voltage Vnf is set to be close to a discharge firing voltage between the Y and X electrodes. Then, a wall voltage between the Y and X electrodes reaches near 0V, and therefore, a cell 12 (FIG. 2) that was not addressed with an address discharge during the address period may be prevented from misfiring during the sustain period. The wall voltage between the Y and A electrodes is determined by the magnitude of Vnf because the voltage of the A electrode is maintained at the reference voltage.

Subsequently, during the address period for selecting turn-on cells 12, a scan pulse VscL and an address pulse Va are applied to Y electrode and A electrode of the turn-on cell 12 (FIG. 2), respectively. A non-selected Y electrode is biased at a voltage of VscH which is higher than VscL, and the reference voltage is applied to the A electrode of the cell being turned off. The scan buffer board 300 selects a Y electrode to be applied with the scan pulse of VscL, among the scan electrodes Y1 to Yn. For example, in the single driving method, the Y electrodes may be selected in an order of arrangement of the Y electrodes in the column direction. When a Y electrode is selected, the address buffer board 100 selects cells 12 to be turned on among the cells along the selected Y electrode. That is, the address buffer board 100 selects the A electrodes to which the address pulse of the voltage of Va is applied among the address electrodes A1 to Am.

The scan pulse, in the form of the voltage VscL, is first applied to the Y electrode in the first row (Y1). At the same time, the address pulse, in the form of the voltage Va, is applied to the A electrode on the cells 12 to be turned on along the first row. Then, a discharge is generated between the Y electrode in the first row (Y1) and the A electrode receiving the voltage Va. Accordingly, (+) wall charges are formed on the Y electrode and (−) wall charges are formed on the A electrode and X electrode. As a result, a wall voltage, Vwxy, is formed between the X and Y electrodes with the potential of the wall adjacent the Y electrode higher than the potential of the wall adjacent the X electrode. Subsequently, while the scan voltage, in the form of the voltage VscL, is applied to the Y electrode in a second row (Y2), the address pulse, in the form of the voltage Va, is applied to the A electrodes in cells 12 to be turned on along the second row. Then, the address discharge is generated in the cells 12 crossed by the A electrodes receiving the voltage Va and the Y electrode in the second row (Y2) and accordingly, wall charges are formed in those cells 12, in the manner described above. Regarding Y electrodes in other rows, wall charges are formed in cells 12 to be turned on in the same manner as described above, i.e., by applying the address pulse, the voltage Va, to A electrodes on cells to be turned on 12 while sequentially applying a scan pulse, voltage VscL, to the Y electrodes from the first row (Y1) to the last row (Yn).

During the address period described above, the voltage VscL is usually set to be equal to or lower than the voltage Vnf, and the voltage Va is usually set to be higher than the reference voltage. Generation of address discharge by applying the voltage Va to the A electrode will now be described in connection with the case that the voltage VscL equals the voltage Vnf. When the voltage Vnf is applied in the reset period, a sum of the wall voltage between the A and Y electrodes and the external voltage Vnf between the A and the Y electrodes reaches the discharge firing voltage Vfay between the A and Y electrodes. For example, when 0V is applied to the A electrode and the voltage VscL, that is equal to Vnf in this case, is applied to the Y electrode in the address period, the voltage Vfay is formed between the A and Y electrodes, and accordingly generation of a discharge may be expected. However, in this case, the expected discharge is not generated because a discharge delay is greater than the width of the scan pulse and the address pulse. However, if the voltage Va is applied to the A electrode and the voltage VscL=Vnf is applied to the Y electrode, a voltage greater than the firing voltage Vfay is formed between the A and Y electrodes, and accordingly, the discharge delay is reduced to less than the width of the scan pulse, allowing a discharge to be generated. The voltage difference between the electrodes A and Y is increased as the magnitudes of Va and VscL are increased, because Va is positive and VscL is negative and an increase in their magnitudes means a greater voltage difference between them. Similarly, generation of the address discharge may be facilitated by setting the voltage VscL to be lower than the voltage Vnf.

Subsequently, during the sustain period, a sustain discharge is generated between the Y and X electrodes by initially applying a pulse, in the form of the voltage Vs, to the appropriate Y electrode. Just before the application of this voltage, the wall voltage Vwxy is formed such that the potential of the Y electrode is higher than the X electrode in the cells 12 having undergone the address discharge in the address period. During the sustain period, the voltage Vs is set to be lower than the discharge firing voltage Vfxy, while the sum of the voltages Vs+Vwxy is set to be higher than the voltage Vfxy. In this manner, the positive wall voltage Vwxy, from the Y electrode to the X electrode, existing before the application of Vs does not generate a discharge. At the same time, once Vs arrives, the sum of these two generally positive voltages will reach above the required firing voltage discharge between X and Y and a discharge is sustained.

As a result of the sustain discharge, the (−) wall charges are formed on the Y electrode and the (+) wall charges are formed on the X and A electrodes, such that the potential of the X electrode wall is higher than the Y electrode wall. Because the voltage Vwyx is formed such that the potential of the Y electrode itself, and not its adjacent wall, becomes higher than the X electrode itself, a pulse of a negative voltage −Vs is applied to the Y electrode to fire a subsequent sustain discharge. As a result of this discharge, once again (+) wall charges are formed on the Y electrode and (−) wall charges are formed on the X and A electrodes such that another sustain discharge may be generated by applying the positive voltage Vs to the Y electrode.

The process of alternately applying the sustain discharge pulses of Vs and −Vs to the Y electrode is repeated a number of times corresponding to a weight value of a corresponding subfield.

As described above, according to the first embodiment of the present invention shown in FIG. 4, reset, address, and sustain operations may be performed by a driving waveform applied only to the Y electrode while the X electrode is biased at the reference voltage. Accordingly, a driving board for driving the X electrode is not required and the X electrode may stay simply biased at a reference voltage, for example at 0V.

As shown in FIG. 4, according to the first exemplary embodiment the final voltage Vnf, that is a voltage applied to the Y electrode during the falling period of the reset period, may be near the discharge firing voltage, Vfxy, between the Y and X electrodes. However, at the final voltage Vnf of the falling period, a wall potential of the Y electrode with respect to the A electrode may be a positive voltage because the discharge firing voltage Vfay between the Y and A electrodes is generally less than discharge firing voltage Vfxy between the Y and X electrodes.

A reset period of a subsequent subfield begins while the above wall charge state is maintained in the cells 12, because the sustain discharge is not generated in cells 12 that have not undergone an address discharge.

In the above state of cell 12 (FIG. 2), the wall potential of the Y electrode with respect to the X electrode is higher than the wall potential of the Y electrode with respect to the A electrode. Therefore, when the voltage of the Y electrode is increased in the rising period of the reset period, the voltage between the X and Y electrodes may exceed the discharge firing voltage, Vfxy, after the voltage between the A and Y electrodes exceeds the discharge firing voltage Vfay.

In a PDP, the X and Y electrodes are typically covered with a material of a high secondary electron emission coefficient for increasing sustain-discharge performance, while the A electrode is covered with a phosphor for color representation. An MgO film may be used for such a material of a high secondary electron emission coefficient. The discharge in the cell 12 (FIG. 2) is determined by the amount of secondary electrons emitted from the negative electrode when positive ions collide against the negative electrode. This secondary electron emission from the Y electrode is referred to as “γ process.”

During the rising period of the reset period, the Y electrode operates as a positive electrode and the A electrode and X electrode operate as negative electrodes because a higher voltage is applied to the Y electrode.

During the rising period, however, the discharge may be delayed between the A and Y electrodes because the phosphor covered A electrode operates as the negative electrode when the voltage between the A and Y electrodes exceeds the discharge firing voltage Vfay. Due to the discharge delay, at the time that the discharge is actually generated between the Y and A electrodes, the voltage between the Y and A electrodes, Vay, is greater than the discharge firing voltage, Vfay. Accordingly, a strong discharge rather than a weak discharge may be generated between the Y and A electrodes due to the high voltage caused by the discharge delay.

Another strong discharge may be generated between the X and Y electrodes by the strong discharge between the A and Y electrodes. Therefore, more positive wall charges may be formed in the cells 12 than charges that would form during a normal rising period, and a greater number of priming particles may be generated.

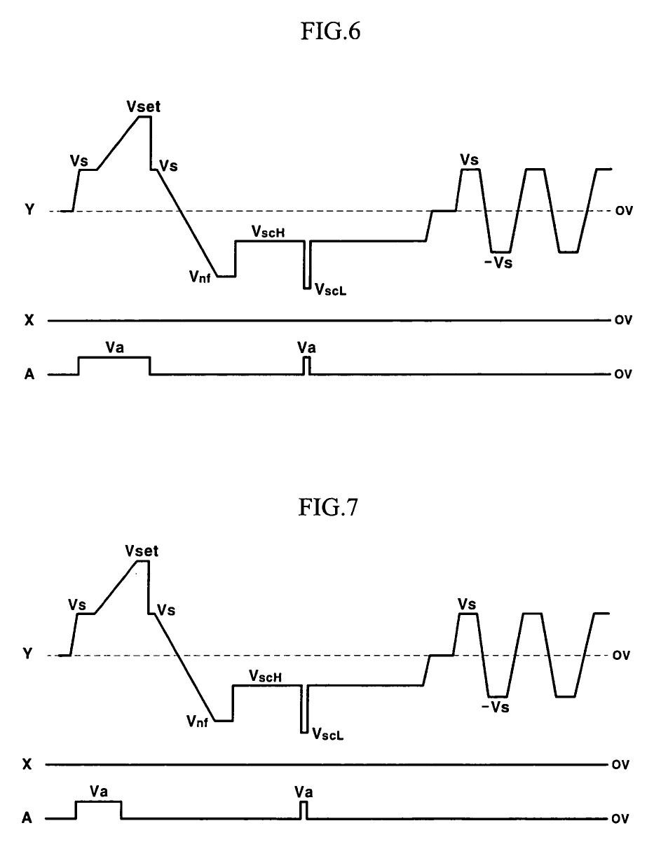

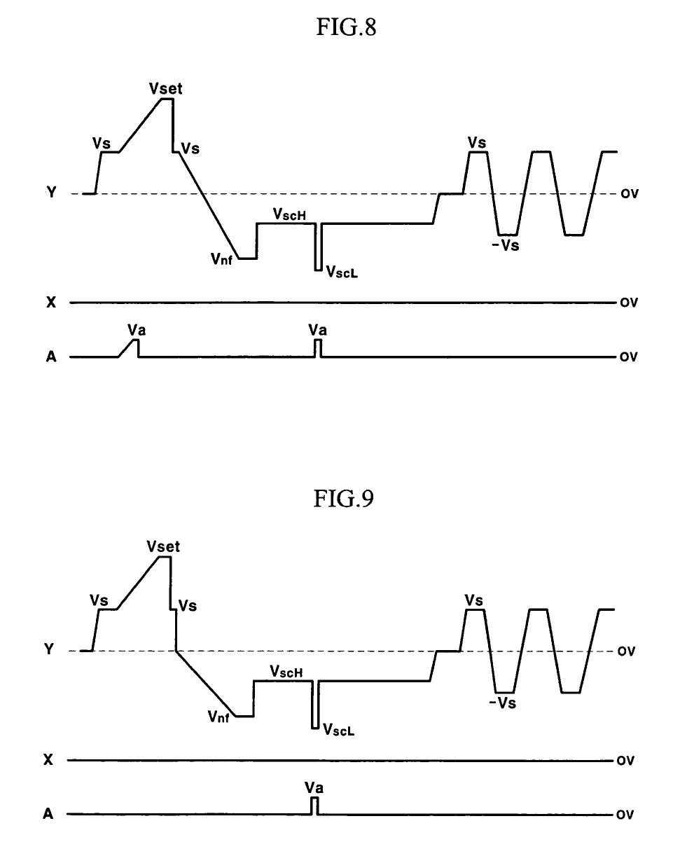

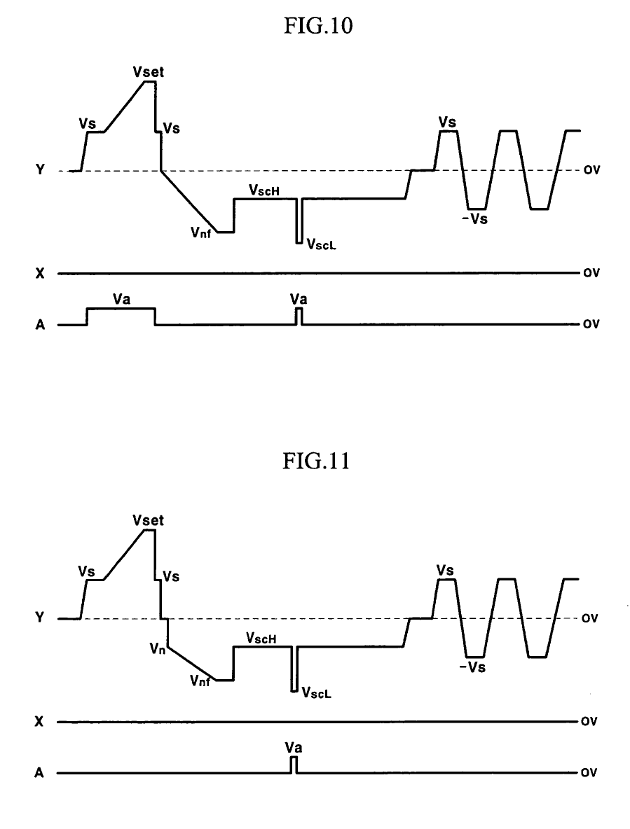

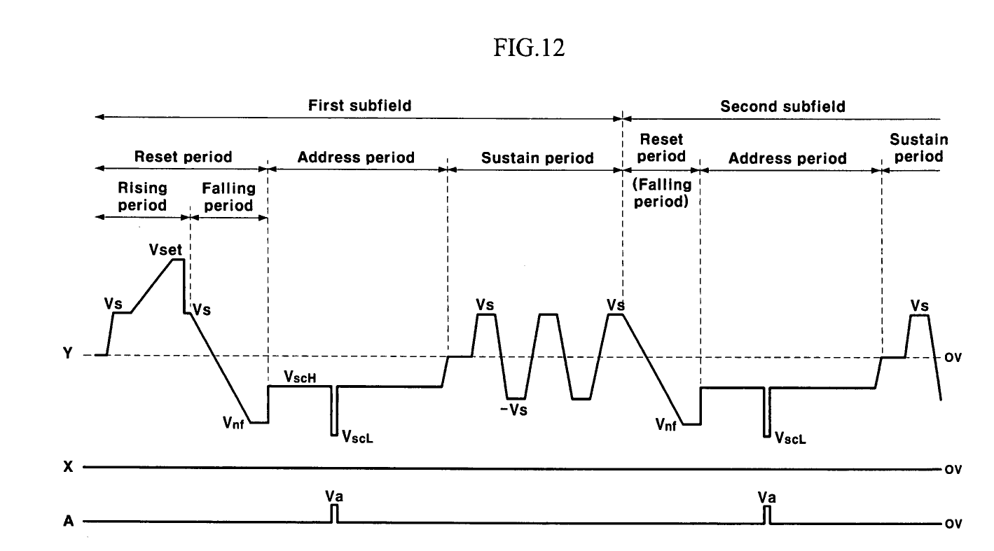

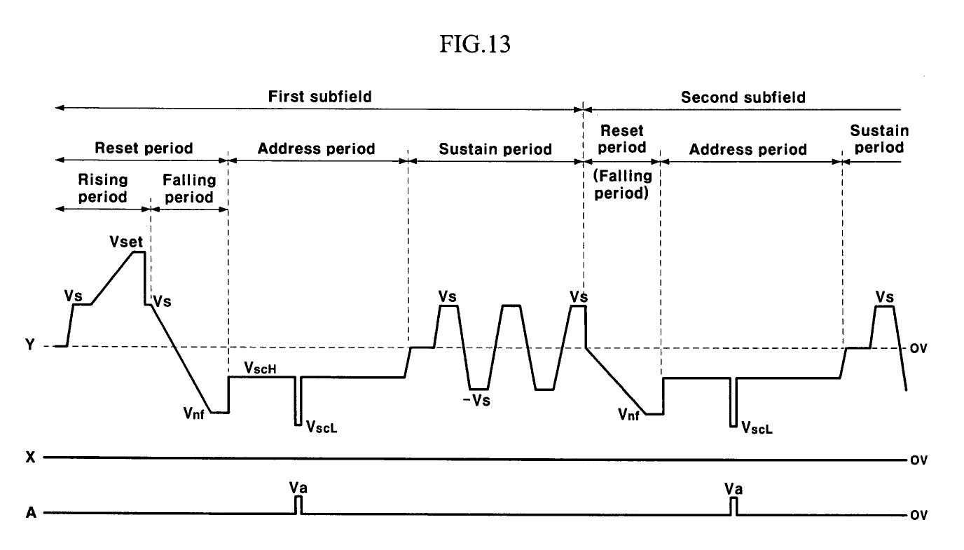

Accordingly, a strong discharge may be generated during the falling period by the wall charges and the priming particles, and the wall charges between the X and Y electrodes, shown in FIG. 5, may not be properly eliminated. In this case, a high wall voltage, Vwxy, may remain between the X and Y electrodes in the cell 12 (FIG. 2) when the reset period ends. This high wall voltage may generate a misfiring between the X and Y electrodes during the sustain period. FIG. 6, FIG. 7, FIG. 8, FIG. 9, FIG. 10, and FIG. 11 show exemplary embodiments for preventing this misfiring discharge.

FIG. 6, FIG. 7, and FIG. 8 respectively show driving waveforms of the plasma display panel according to second to fourth exemplary embodiments of the present invention.

As shown in FIG. 6, while the driving waveform according to the second exemplary embodiment of the present invention is similar to the first exemplary embodiment, the A electrode, in the second embodiment, is biased at a positive voltage in the reset period of the rising period. In the second embodiment, during the rising period of the reset period, the voltage of the Y electrode is gradually increased from the voltage Vs to the voltage Vset while the A electrode is biased at a constant voltage Va which is higher than the reference voltage. Accordingly, it is not necessary to use an additional power source to apply the bias voltage to the A electrode if a constant voltage Va is used as the bias voltage of the A electrode. When the voltage of the Y electrode is increased while the A electrode is biased at the voltage Va, the voltage between the A and Y electrodes is less than the voltage between these two electrodes in the first exemplary embodiment of FIG. 5. Therefore the voltage between the X and Y electrodes exceeds the discharge firing voltage before the voltage between the Y and A electrodes exceeds the discharge firing voltage. As a result, a weak discharge is generated between the X and Y electrodes thereby forming priming particles, and the voltage between the A and Y electrodes exceeds a discharge firing voltage. The discharge delay is reduced between the A and Y electrodes by the priming particles. Accordingly, a weak discharge instead of a strong discharge is generated between the A and Y electrodes, and wall charges are properly formed. Therefore, misfiring may also be prevented in the falling period of the reset period because a strong discharge was not generated

While the A electrode is biased at the constant voltage Va during the rising period in the second embodiment shown in FIG. 6, the A electrode may be biased at the constant voltage Va only in an early stage of the rising period in the third exemplary embodiment shown in FIG. 7. As described above, a strong discharge during the rising period may be prevented by preventing the voltage between the A and Y electrodes from exceeding the discharge firing voltage prior to the time that the voltage between the X and Y electrodes exceeds the discharge firing voltage. Therefore, the A electrode may be biased at the constant voltage Va only at the early stage of the rising period. After the weak discharge is generated between the A and Y electrodes, the voltage of the A electrode may be set back to the reference voltage, for example 0V.

While the A electrode is biased at the constant voltage Va during the rising period in the first and second embodiments shown in FIG. 6 and FIG. 7, instead the voltage of the A electrode may be gradually increased according to the fourth exemplary embodiment shown in FIG. 8. When the voltages of the Y and A electrodes are increased together, a weak discharge is generated between the X and Y electrodes because the voltage between the A and Y electrodes is further reduced to less than this same voltage when the A electrode is biased at the reference voltage of for example 0V. The voltage of the A electrode may be increased during the entire duration of the rising period or during only a portion of this period.

Also, instead of increasing the voltage of the A electrode as shown in FIG. 8, the A electrode may be floated. When the voltage of Y electrode is increased and the A electrode is floated, the voltage of the A electrode increases according to an increase in the voltage of the Y electrode because of a capacitance formed between the A and Y electrodes, thereby achieving the waveform shown in FIG. 8. The voltage of the A electrode may be floated during the entire duration of the rising period or during only a portion of this period.

While a weak discharge is generated by increasing the voltage of the A electrode above the reference voltage during the rising period in FIG. 6, FIG. 7, and FIG. 8, a decreasing slope of the voltage of the Y electrode may be controlled in the falling period according to the fifth exemplary embodiment of the present invention shown in FIG. 9.

As shown in FIG. 9, the driving waveform according to the fifth exemplary embodiment of the present invention is similar to the first exemplary embodiment. However, in the fifth embodiment, during the falling period of the reset period, the voltage of the Y electrode is reduced to a voltage lower than the voltage Vs. In FIG. 9, for example, the falling start voltage is at 0V line and the Y electrode voltage starts to fall along a slope from 0V. When the falling start voltage of the Y electrode is set lower, the falling slope of the Y electrode voltage will be gentler during the predetermined falling period.

As the voltage slope of an electrode becomes gentler, the discharge is generated more weakly. Although a strong discharge is generated during the rising period, a strong discharge during the falling period is prevented because the voltage of the Y electrode is varied more slowly than in the first exemplary embodiment. In this embodiment, it is not necessary to include an additional power source to be applied to the Y electrode when the reference voltage 0V is used for the falling start voltage.

When the falling start voltage of the Y electrode is 0V, like the example shown in FIG. 9, no discharge is generated because a difference between voltages applied to the X and Y electrodes and a difference between voltages applied to the A and Y electrodes are 0V at the time that the Y electrode voltage begins to fall. When the voltage of the Y electrode is gradually reduced, a weak discharge is generated in a case that a difference between the wall voltage formed on the cell 12 (FIG. 2) and the externally applied voltage exceeds the discharge firing voltage.

FIG. 10 shows a diagram for representing a driving waveform according to the sixth exemplary embodiment of the invention. As shown in FIG. 10, the driving waveform of the Y electrode in the fifth exemplary embodiment may be applied to the second to fourth exemplary embodiments. For example, the falling start voltage of the driving waveform is set to be 0V. Accordingly, a strong discharge is prevented in the rising period of the reset period, and the slope of the falling period is reduced because the falling start voltage is lowered.

While the falling start voltage of the Y electrode is set to be 0V in FIG. 9, the falling start voltage may be set to be a negative voltage, Vn, as shown in FIG. 11 illustrating the seventh exemplary embodiment. When the rising period of the reset period ends, the wall voltage Vwxy between the Y and X electrodes is given by Equation 1. To prevent a strong discharge during the falling period, the discharge must be generated when the voltage of the Y electrode is lowered below falling start voltage Vn. As shown in Equation 2, at the falling start voltage Vn, the voltage formed between the Y and X electrodes is less than the discharge firing voltage. Accordingly, the falling start voltage Vn satisfies Equation 3.
Vwxy=Vset−Vfxy [Equation 1]
Vwxy−Vn<Vfxy [Equation 2]
Vn>Vwxy−Vfxy=Vset−2Vfxy [Equation 3]

Generally, the cells in all conditions are to be initialized in the reset period, and therefore a difference between the maximum voltage and minimum voltage applied in the reset period is set to be a voltage 2Vfxy or a voltage which greater than the voltage 2Vfxy. In this embodiment, the voltage Vnf is set to be a negative voltage −Vfxy of the discharge firing voltage Vfxy. Accordingly, the maximum voltage during the reset period, Vset, is given by Equation 4.
Vset>2Vfxy+Vnf≈Vfxy [Equation 4]

Accordingly, the voltage Vn may be set to be a negative voltage when the voltage Vset is set to be a voltage between the voltage Vfxy and the voltage 2Vfxy.

When the voltage Vnf is approximated as the negative voltage −Vfxy of the discharge firing voltage Vfxy, Equation 3 may be represented as Equation 5. Then, the falling start voltage Vn of the Y electrode is reduced to a voltage range that satisfies Equation 5.
Vn>Vset+2Vnf [Equation 5]

When the voltage Vn is a negative voltage and the voltage of the Y electrode is directly reduced from the voltage Vset to the voltage Vn, a self erasing discharge is generated because of a large voltage change. The self erasing discharge may be prevented by reducing the voltage of the Y electrode, from the voltage Vset to the voltage Vn, in a step by step fashion. For example, the voltage of the Y electrode may be reduced from Vset to Vs, from Vs to 0V, and then from 0V to Vn. Alternatively, the voltage of the Y electrode may be reduced from Vset to Vs and from Vs to Vn.

As explained above, embodiments of the invention don't require a board for driving the X electrode, because the reset, address, and sustain discharge operations are performed by applying the driving waveform to the Y electrode while the X electrode is biased at a constant voltage. In addition, the impedance on the path for applying the sustain discharge pulse may be controlled to be within a certain level because the pulse for the sustain discharge is supplied by the scan buffer board 300.

The respective reset periods of a plurality of subfields forming one field may each include a rising period and a falling period like the reset period shown in FIG. 4. However, as shown in FIG. 12, the reset periods of some subfields may include the falling period only.

FIG. 12 shows a diagram for representing the driving waveform of a plasma display panel according to the eighth exemplary embodiment of the present invention. In FIG. 12, two subfields of a plurality of subfields are represented and for convenience of description, the two subfields are respectively illustrated as a first subfield and a second subfield. The reset period of the first subfield includes a rising period and a falling period, and the reset period of the second subfield includes the falling period only.

The driving waveform of the first subfield in FIG. 12 is similar to the driving waveform of the first embodiment shown in FIG. 4. However, the reset period of the second subfield includes only a falling period. The voltage of the Y electrode is gradually reduced to the voltage Vnf in the reset period of the second subfield while the sustain discharge pulse of Vs is applied to the Y electrode in the sustain period of the first subfield.

During the sustain period of the first subfield, a sustain discharge is generated and (−) wall charges form on the Y electrode and (+) wall charges form on the X and A electrodes. As a result, a weak discharge is generated during the falling period of the reset period of the second subfield. This discharge is similar to the discharge generated during the falling period of the reset period of the first subfield when the voltage of the Y electrode is gradually reduced and exceeds the discharge firing voltage.

The wall charge condition in the cell 12 (FIG. 2) after the falling period of the second subfield is equivalent to the wall charge condition after the falling period of the first subfield because the final voltage Vnf of the Y electrode in the falling period of the second subfield is equal to the final voltage Vnf of the Y electrode in the falling period of the first subfield.

The wall charge condition in the cell 12 (FIG. 2) is maintained at a condition of the end of the falling period of the first subfield because the address discharge is not generated if the sustain discharge has not been generated during the sustain period of the first subfield. No discharge is generated when the voltage of the Y electrode is reduced to Vnf. As a result of the applied voltages, after the falling period of the first subfield is finished, the wall voltage formed on the cell 12 (FIG. 2) reaches near the discharge firing voltage. Accordingly, the wall charge condition established in the reset period of the first subfield is maintained because no discharge is generated in the reset period of the second subfield.

As described, in the case of the subfield having a falling period without rising a period during the reset period, a reset discharge is generated when the sustain discharge is generated in a previous subfield, and reset discharge is not generated when the sustain discharge is not generated in the previous subfield. Accordingly, the reset discharge (weak discharge) is generated in the reset period of a very first subfield when 0 gray scales (black gray scales) are displayed if the very first subfield is formed like the first subfield of FIG. 13 and other subfields are formed like the second subfield of FIG. 13. As a result, the contrast ratio is increased because discharge is not generated in other subfields when the black gray scales are displayed.

While the driving waveform of the first exemplary embodiment has been used to describe the eighth exemplary embodiment in FIG. 12, the driving waveforms described in the second to sixth exemplary embodiments may also be used similarly.

In addition, as shown in FIG. 13, a start voltage in the falling period of the second subfield may be set to be a voltage lower than the voltage Vs of the fifth to seventh exemplary embodiments.

While the driving voltage of the ninth exemplary embodiment of FIG. 13 is similar to the driving voltage of the eighth exemplary embodiment of FIG. 12, the falling start voltage of the Y electrode in FIG. 13 is lower than the voltage Vs which is the falling start voltage of FIG. 12. With a lower start, the falling slope of the Y electrode may be set to be gentler during the falling period of the second subfield. It is not necessary to form an additional power source to apply the falling start voltage to the Y electrode when the falling start voltage is set to be 0V as shown in FIG. 13.

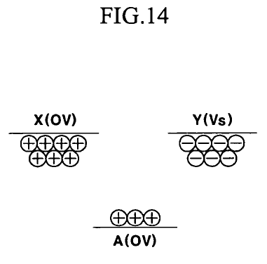

When the sustain period ends and the wall voltage caused by the wall charges do not exceed the discharge firing voltage, then the wall charges form on the X and Y electrodes as shown in FIG. 14. In this cell condition, discharge is not generated because the voltage is formed in the cell 12 (FIG. 2) by the wall charges when the voltage of the Y electrode is 0V. Accordingly, the falling start voltage of the Y electrode is set to be lower than 0V.

While the voltage of the Y electrode is gradually reduced, discharge is generated when a sum of the wall voltage and the voltage applied to the X and Y electrodes exceeds the discharge firing voltage Vfxy. At this time, the falling voltage of the Y electrode is higher than the voltage −Vs because discharge is generated when the voltage −Vs is applied to the Y electrode as described above.

Accordingly, the falling slope of the Y electrode voltage is set to be gentle in the predetermined falling period of the Y electrode voltage, and the falling period is reduced when the falling start voltage of the Y electrode is set to be lower than 0V.

According to the exemplary embodiments of the present invention, a board for driving the sustain electrode is not required because the driving waveform is applied to the scan electrode while the sustain electrode is biased at a constant voltage. A single integrated board is sufficient for driving the electrodes and the cost is reduced.

When the Y and X electrodes have separate driving boards, the impedance formed on the scan driving board is different from the impedance formed on the sustain driving board. This difference occurs because the driving waveforms in the reset period and the address period are supplied mainly from the scan driving board. As a result, the sustain discharge pulse applied to the scan electrode in the sustain period and the sustain discharge pulse applied to the sustain electrode are different. According to the exemplary embodiments of the present invention, however, the impedance on the path for applying the sustain discharge pulse may be controlled to be within a certain level because the pulse for the sustain discharge is supplied from the scan driving board.

While this invention has been described in connection with what is presently considered to be practical exemplary embodiments, it is to be understood that the invention is not limited to the disclosed embodiments, rather, is intended to cover various modifications and equivalent arrangements included within the spirit and scope of the appended claims.

1. A method for driving a plasma display panel, the plasma display panel including a scan electrode, a sustain electrode, and an address electrode, the scan electrode and the sustain electrode forming a parallel pair and the address electrode extending perpendicular to the parallel pair, the method driving the plasma display panel during frames, each frame having subfields, each subfield having a reset period followed by an address period followed by a sustain period, the reset period including a rising period followed by a falling period, the method comprising:
maintaining the sustain electrode biased at a first voltage, during each subfield;
gradually increasing a voltage of the scan electrode from a second voltage to a third voltage, during the rising period;
decreasing the voltage of the scan electrode from the third voltage to a fourth voltage;
gradually decreasing the voltage of the scan electrode from the fourth voltage to a fifth voltage, during the falling period;
selecting a discharge cell by applying a scan voltage and a non-scan voltage to the scan electrode and applying an address pulse to the address electrode, during the address period; and
sustain-discharging the selected discharge cell by applying a pulse alternately having a sixth voltage and a seventh voltage lower than the sixth voltage to the scan electrode, during the sustain period,
wherein the address electrode is biased at an eighth voltage during the falling period and a portion of the address period.

2. The driving method of claim 1, wherein the address electrode is biased at a ninth voltage more positive than the eighth voltage during the entire rising period.

3. The driving method of claim 1, wherein the address electrode is biased at a ninth voltage more positive than the eighth voltage during a portion of the rising period.

4. The driving method of claim 1, wherein the voltage of the address electrode is gradually increased to a voltage more positive than the eighth voltage during a portion of the rising period.

5. The driving method of claim 1, wherein the address electrode is floated during the rising period.

6. The driving method of claim 2, wherein the ninth voltage is equal to the address pulse voltage.

7. The driving method of claim 1, wherein the first voltage is a ground voltage.

8. The driving method of claim 1, wherein the fourth voltage is a ground voltage.

9. The driving method of claim 1, wherein the sixth voltage is equal to the fourth voltage.

10. The driving method of claim 1, wherein the eighth voltage is a ground voltage.

11. The driving method of claim 1,
wherein the third voltage is a positive voltage,
wherein the fifth voltage is a negative voltage with an absolute value greater than the third voltage, and
wherein the fourth voltage is lower than the ground voltage and is higher than a sum of the third voltage and a voltage twice the fifth voltage.

12. The driving method of claim 11, wherein the voltage of the scan electrode is decreased from the third voltage to the sixth voltage and from the sixth voltage to the ground voltage, between the rising period and the falling period, and then gradually decreased from the ground voltage to the fifth voltage, during the falling period.

13. The driving method of claim 1, wherein the reset period of a first subfield includes the rising period and the falling period, and reset periods of subsequent subfields include the falling period only, the driving method further comprising:
gradually decreasing the voltage of the scan electrode from the fourth voltage to the fifth voltage, during the falling period of a subsequent subfield.

14. The driving method of claim 13, wherein gradually decreasing the voltage of the scan electrode from the fourth voltage to the fifth voltage, during the falling period of a subsequent subfield, includes first decreasing the voltage of the scan electrode from the fourth voltage to ground and then gradually decreasing the voltage of the scan electrode from ground to the fifth voltage.

15. A plasma display device comprising:
a plasma display panel having a plurality of sustain electrodes, a plurality of scan electrodes, and a plurality of address electrodes, the address electrodes crossing the sustain electrodes and the scan electrodes, and an intersection of the sustain electrodes and the scan electrodes with the address electrodes forming cells;
a control board for dividing a frame into a plurality of subfields; and
a driving board for applying a driving waveform, for displaying an image on the plasma display panel, to the scan electrodes and to the address electrodes, and for biasing the sustain electrodes at a first voltage during the plurality of subfields,
wherein the driving board generates a discharge for initializing a cell during a reset period of at least one subfield, the discharge generated first between the scan electrodes and the address electrodes and then between the scan electrodes and sustain electrodes.

16. The plasma display device of claim 15, wherein the driving board generates a discharge by gradually increasing a voltage of the scan electrodes and subsequently gradually decreasing the voltage of the scan electrodes.

17. The plasma display device of claim 16, wherein the driving board generates the discharge by gradually decreasing the voltage of the scan electrodes from the reference voltage.

18. The plasma display device of claim 16, wherein the driving board generates the discharge by gradually decreasing the voltage of the scan electrodes from a voltage lower than the reference voltage.

19. The plasma display device of claim 16, wherein the driving board applies a voltage to the address electrodes during a period when the driving board gradually increases the voltage of the scan electrodes, the voltage applied being more positive than a voltage applied to the address electrodes during a period when the driving board gradually decreases the voltage of the scan electrodes.

20. A driving method for a plasma display panel having a plurality of first electrodes, a plurality of second electrodes, and a plurality of third electrodes formed crossing the first electrodes and the second electrodes while one frame is divided into a plurality of subfields, the method, in at least one subfield, comprising:
gradually reducing a voltage of the second electrode from a second voltage to a third voltage while the first electrode is biased at a first voltage in a reset period;
selecting a discharge cell in an address period; and
sustain-discharging the selected discharge cell by applying a pulse alternately having a fourth voltage higher than the first voltage and a fifth voltage lower than the first voltage to the second electrode while the first electrode is biased at the first voltage, wherein the second voltage is lower than the fourth voltage.

21. The driving method of claim 20, wherein the second voltage is equal to the first voltage.

22. The driving method of claim 20, wherein the second voltage is lower than the first voltage and higher than the fifth voltage.

23. The driving method of claim 20, further comprising:
gradually increasing the voltage of the second electrode from a sixth voltage to a seventh voltage while the first electrode is biased at the first voltage before the voltage of the second electrode is reduced in the reset period.

24. The driving method of claim 23, wherein a voltage of the third electrode is set to be higher than the first voltage in at least a period when the voltage of the second electrode is increased from the sixth voltage to the seventh voltage.

25. The driving method of claim 23, wherein the voltage of the second electrode is reduced from the fourth voltage to the second voltage after the voltage of the second electrode is reduced from the seventh voltage to the fourth voltage.

26. The driving method of claim 20, wherein the first voltage is a ground voltage.

27. A plasma display device comprising:
a plasma display panel having a plurality of first electrodes, a plurality of second electrodes, and a plurality of third electrodes formed crossing the first electrodes and the second electrodes;
a control board for dividing a frame into a plurality of subfields; and
a driving board for applying a driving waveform displaying an image on the plasma display panel to the second and third electrodes, and biasing the first electrode at the first voltage in the respective subfields,
wherein the driving board initializes a discharge cell by reducing a voltage of the second electrode from a fourth voltage to a fifth voltage after gradually increasing the voltage of the second electrode from a second voltage to a third voltage in a reset period of a first subfield of the plurality of subfields,
wherein the driving board initializes the discharge cell by reducing the voltage of the second electrode from a sixth voltage to a seventh voltage in a reset period of a second subfield of the plurality of subfields, and
wherein at least one of the fourth voltage and the sixth voltage is lower than or equal to the first voltage.

28. The plasma display device of claim 27, wherein the fourth voltage is equal to the sixth voltage, and the fifth voltage is equal to the seventh voltage.

29. The plasma display device of claim 27, wherein the driving board sets the voltage of the third electrode to be higher than the first voltage in at least a partial period when the voltage of the second electrode is increased from the second voltage to the third voltage.

30. The plasma display device of claim 27, wherein the first voltage is a ground voltage.

31. The plasma display device of claim 16, wherein the driving board applies a pulse alternately having a voltage higher than a reference voltage and a voltage lower than the reference voltage to the scan electrodes in order to perform a sustain discharge.
